(19) United States
(12) Patent Application Publication
(10) Pub. No.: US 2011/0119126 A1
(43) Pub. Date: May 19, 2011

(54) Online Monitoring Systems to Determine Offline Advertising Effectiveness

(75) Inventors: John B. Park, Irvine, CA (US); Daryl Pregibon, Hoboken, NJ (US); Neha Singh, New York, NY (US); Leo Deegan, San Francisco, CA (US)

(73) Assignee: GOOGLE INC., Mountain View, CA (US)

(21) Appl. No.: 12/621,966

(22) Filed: Nov. 19, 2009

(51) Int. Cl. G06Q 30/00

(52) U.S. Cl. 705/14.45; 705/14.41

(57) ABSTRACT

Methods, systems, and apparatuses for online monitoring systems to determine offline advertising effectiveness. Information related to an advertisement for a product is received. The advertisement is presented through offline media. The information includes an advertising schedule. Communications related to the product that are received from the consumers in the market at the time the advertisement is presented, are detected. Data responsive to the detected communications are collected; the data represent a number of consumers in the market. A statistical correlation between the collected data and the advertising schedule is determined and provided to the advertiser as a report of the effectiveness of the advertising.

### TECHNICAL FIELD

The present specification relates to advertising through offline media, for example, radio, television, print, and the like.

### BACKGROUND

An advertisement campaign includes advertisements directed to products or services presented through media for a designated duration (typically, days, weeks or months). The effectiveness of an advertisement campaign can be measured by a measure of return on investment (ROI) that represents, for example, an increase in consumers purchasing a product due to exposure to the advertisement.

In online advertisement campaigns for products, advertisements are presented to consumers who use computers in a network, for example, the Internet. Such advertisements include, for example, a flash video showing the product being advertised and a uniform resource locator (URL) that points to a website where details related to the product are described. The advertisement is presented on multiple websites when consumers access the websites. The return on investment of such an online advertisement campaign can be a function of multiple variables including a number of times the URL included in the advertisement is clicked.

In offline advertising, for example, advertisements are presented to consumers located within a geographic region. To advertise to such consumers, the advertising campaign can include presenting advertisements through media such as radio, television, print, and the like, for a duration. The ROI of the offline advertising campaign can be based on, for example, an increase in a number of consumers who visit the store during the campaign in comparison to a number of consumers who otherwise visit the store absent the advertising.

### SUMMARY

This specification describes technologies relating to online monitoring systems to determine offline advertising effectiveness.

In one example, an advertiser conducts an offline advertising campaign to promote a product by broadcasting an advertisement related to the product on a radio station. The advertisement includes a URL to a website on which the advertised product is sold. Upon listening to the advertisement, consumers visit the website using computers connected to the Internet. A monitoring system tracks a number of times the website is visited and also tracks information related to each visit such as a duration of the visit, a number of web pages in the website that were visited, a number of purchases of the product through the website, and the like. By comparing a number of visits to the website during the advertisement campaign to a number of visits before or after the campaign or both, and using a number of visits to the website by consumers in markets other than the market in which the advertisement campaign was run, the monitoring system develops a correlation between the collected information and the advertisement campaign. Using the correlation, the number of visits in the targeted market in the absence of the advertising can be determined, which indicates an effectiveness of the advertisement campaign. Thus, the monitoring system determines an effectiveness of an offline advertising campaign by performing on-line monitoring of consumer activity. Other examples by which the monitoring system determines effectiveness of offline advertisement campaigns are also described.

In one aspect, a method performed by one or more computers is described. The method includes receiving, by one or more computers, information related to an advertisement for a product. The advertisement is presented through offline media other than a public, packet-switched data network. The information includes an advertising schedule based on which the advertisement is to be presented to a market including consumers. The method further includes detecting, by the one or more computers, communications related to the product from the consumers in the market at times in the advertising schedule during which the advertisement is presented. The detected communications are received through offline media and a public, packet-switched data network. The method further includes collecting, by the one or more computers, data responsive to the detected communications. The data represents a number of consumers in the market from which the communications related to the product were detected responsive to the advertisement. The method also includes providing, by the one or more computers, a report of the effectiveness based at least in part on the determined statistical correlation.

This, and other aspects, can further include one or more of the following features. The method can further include detecting communications related to the product from consumers in a market other than the market in which the advertisement is presented, collecting other data responsive to the communications detected from the market other than the market in which the advertisement is presented, and including the other data in determining the statistical correlation. The method can further include receiving the information related to the advertisement from an advertiser, and providing the statistical correlation representing the effectiveness to the advertiser. The information can include a website of the product that is stated when the advertisement is presented. The communications related to the product can include an accessing of the website. The collected data can include a number of times consumers access the website. The public, packet-switched network can be the Internet. The information can include a keyword related to the product. The communications related to the product can include searches on the Internet for the keyword. The collected data can include a number of times consumers search the Internet for the keyword. The information can include a telephone number to call to obtain information related to the product. The communications related to the product can include phone calls to the telephone number. The collected data can include a number of times consumers placed the phone calls. The advertisement can be presented through one or more of a radio, a television, or a publication. The method can further include detecting first communications related to the product from consumers in the market for a first time before the advertising schedule is commenced, detecting second communications related to the product from consumers in the market for a second time after the advertising schedule is completed, collecting data responsive to the first communications and the second communications, the data representing a number of consumers in the market from whom the communications related to the product were detected before and after the advertisement was presented, and determining a change in a number of consumers that provided communications related to the product during the advertising schedule in comparison to a number of consumers that provided communications related to the product before and after the advertising schedule. The effectiveness of presenting the advertisement for the product during multiple days of the advertising schedule can be represented by multiple numbers of consumers from whom communications related to the product were detected on the corresponding multiple days. Providing the statistical correlation can include generating a graph of the multiple numbers of consumers v/s the multiple days.

Other aspects include implementations of the above-described method in systems and apparatuses using a computer-readable medium encoding software instructions executable by one or more computers to perform the above-described method.

In another aspect, a computer-readable medium encoding software instructions executable by one or more computers to perform operations is described. The operations include detecting, for a duration, visits to a website related to a product by consumers in a geographical region. The website is identified in an advertisement for the product that is broadcast by a radio station to the geographical region. The duration corresponds to an advertising schedule during which the advertisement is broadcast by the radio station. The operations further include collecting a number of visits to the website at periodic intervals during the duration based on the advertising schedule. The operations also include determining an increase in a number of visits to the website in comparison to an average number of visits to the website for each of the periodic intervals during which the number of visits to the website is collected. The operations further include generating a plot of the increase in the number of visits to the website versus a number of periodic intervals, and providing the generated plot to an advertiser from whom the advertisement was received.

This, and other aspects, can include one or more of the following features. A visit to the website can be defined by an accessing of a uniform resource locator (URL) of the website that is stated when the advertisement is broadcast by the radio station. A consumer can be determined to be within the market if an IP address of a computer using which the consumer accesses the website is included in IP addresses of all computers located within the market. The average number of visits to the website can be determined based on a number of visits to the website before the advertisement for the product is broadcast.

Particular implementations of the subject matter described in this specification can be implemented to realize one or more of the following potential advantages. Developing a statistical correlation between a number of consumers who express interest in an advertised product and a duration of an offline advertisement campaign for the product can enable an advertiser to determine an effectiveness of the campaign. Further, the techniques described here can eliminate the effect of seasonality that can affect the measure of effectiveness of an advertisement campaign. Specifically, because the effectiveness of the ad campaign is measured by comparing consumer response to an ad campaign in a market in which the advertisement is presented to response to the campaign in another market in which the advertisement is not presented, the effect of seasonality on the response to the ad campaign can be eliminated. Because data can be collected and processed during the campaign, real-time effectiveness information can be provided to the advertiser. Further, collecting data using online techniques can enable obtaining effectiveness information with high particularity. In other words, ROI information can be obtained, for example, for each day, each hour, and each minute of the campaign. Consumers can respond to an advertisement through multiple media, for example, by visiting websites related to the product, by calling a telephone number provided in the advertisement, and the like. The monitoring system described here can monitor the various means by which consumers respond to the advertisement and form a single repository of data from which effectiveness information can be retrieved. Using the information related to effectiveness of offline advertising, advertisers can optimize investments in advertising. The monitoring system can offer advertisers a holistic view of the different response mechanisms to advertisements, and can allow advertisers to tailor future advertisement campaigns to one or more specific response mechanisms.

The details of one or more implementations of the specification are set forth in the accompanying drawings and the description below. Other features, aspects, and advantages of the specification will become apparent from the description, the drawings, and the claims.

### BRIEF DESCRIPTION OF THE DRAWINGS

FIG. 1 is an illustration of an example system for online monitoring of offline advertising effectiveness.

FIG. 2 is a flow chart of an example process for online monitoring of offline advertising effectiveness.

FIG. 3 is a schematic of an example monitoring system.

FIGS. 4A and 4B are plots included in a summarized effectiveness report.

FIG. 5 is a flow chart of an example process for generating an effectiveness report.

Like reference numbers and designations in the various drawings indicate like elements.

### DETAILED DESCRIPTION

In an offline advertisement campaign, an advertiser creates an advertisement (“ad creative”) and an advertisement schedule in which the advertiser specifies a duration for which the ad creative will be presented. The advertiser provides the ad creative for selection by one or more offline media, for example, a radio station, a television station, a publication such as a daily newspaper, a weekly periodical, and the like. For example, for advertisements presented on a radio station, an audio system determines radio stations based on target consumers that the advertiser intends to reach. The offline media present the advertisement to consumers for the duration specified in the advertisement schedule. As described below, the ad creative provides consumers with information, for example, a URL of a website, a telephone number, and the like, using which the consumers obtain additional information about the advertised product. As a result of the advertisement campaign, advertisers observe an increase in the interest that consumers express in the product being advertised. For example, consumers visit the website or call the telephone number provided in the advertisement more often than consumers would in the absence of the advertising. Specifically, for example, the increase can represented by a difference between a number of consumers visiting the advertiser's website and/or calling the advertiser's telephone number during or immediately after the offline advertisement campaign as compared to the number of consumers visiting the website and/or calling the telephone number during other times when there is no advertising. Alternatively, or in addition, the increase can be represented by comparing a number of consumers visiting the advertiser's website and/or calling the advertiser's telephone number in the market in which the advertiser ran the campaign to similar numbers from other markets in which the ad campaign was not run.

The monitoring system described below can use online techniques to monitor the consumers' interest in the advertised product and can represent the interest, for example, as a statistical correlation between a number of consumers enquiring about the product and the advertisement schedule. In addition, the monitoring system can provide advertisers with a report generated based on the statistical correlation that describes the effectiveness of the advertisement campaign.

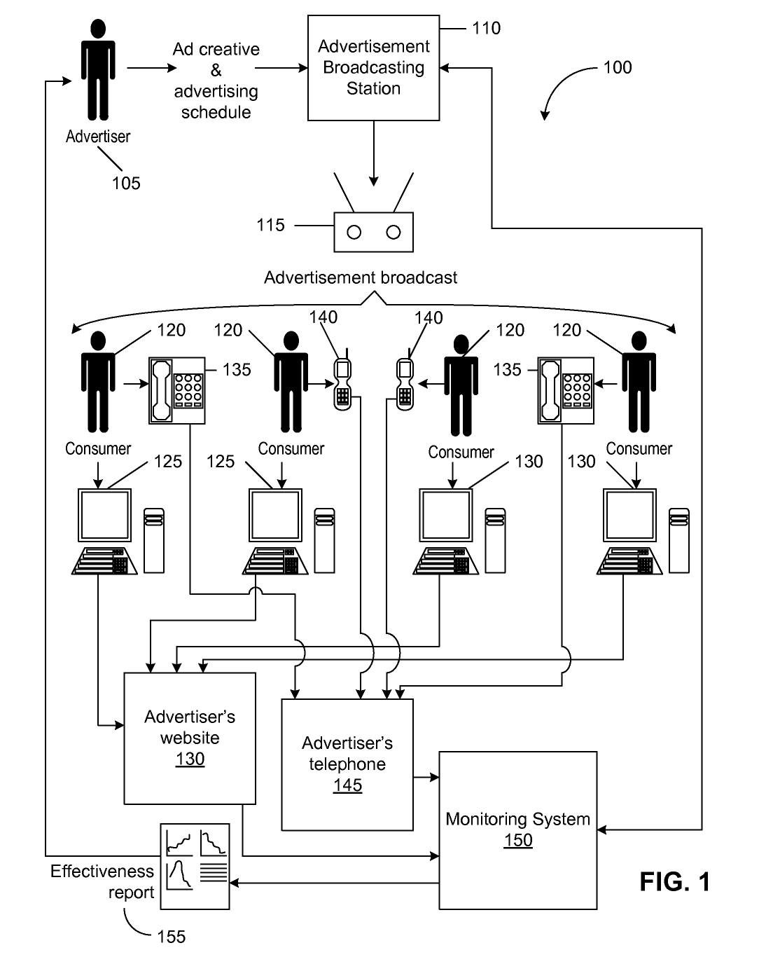

FIG. 1 is an illustration of an example system 100 for online monitoring of offline advertising effectiveness. An advertiser 105 who decides to advertise a product using offline media creates an ad creative and an advertising schedule. In the ad creative, the advertiser 105 provides information related to the product, for example, the nature of the product, a URL of a website describing the product, address and phone number of a location for purchase of the product, SMS text contact number, keywords to search for the product, for example, on a search engine, and the like. Note that the URL of the website that the advertiser provides need not be specific to the ad campaign, but instead can be a general URL using which the consumer can access the advertiser's product's website even in the absence of the ad campaign. For example, the website can be www.1800flowers.com. This is a general URL to the general website that is not specific to the advertisement campaign. Alternatively, or in addition to the general website, a website specific to the advertisement campaign can also be included in the ad creative.

The format of the ad creative can depend upon the offline media in which the creative will be presented. For example, the ad creative can be an audio clip for broadcasting over a radio station, a video clip for display in a television, text for printing in a newspaper, and the like. The advertising schedule specifies a duration for which the ad creative is to be presented. For example, in scenarios where the media is a radio station, the advertiser 105 specifies a period of time in which the ad creative is to be broadcast by the radio station. Alternatively, or in addition, the advertiser 105 can also specify a number of times it is to be broadcast within that period. In addition, the advertiser can specify a reach/frequency, markets, dayparts, and the like. Specifically, for example, when the offline media that the advertiser 105 chooses is print, then the advertiser 105 can specify the newspapers in which they wish the advertisement to be printed. This information can indirectly infer targeting to certain demographics and geolocations. When the offline media is audio, then the advertiser 105 can specify a market in which the audio advertisement should be heard as explained below.

The advertiser 105 provides the ad creative and the advertising schedule to an advertising broadcasting station 110. For example, the advertiser 105 selects a market in which the advertisement is to be heard. Alternatively, or in addition, the advertiser's ad creative can be selected by a system, for example, a system employed by the broadcasting station 110, for presentation to the market. Based on the market, radio station broadcasting across geographic regions encompassed by the market are selected as the advertisement broadcasting station 110 because that region spans a designated market area (DMA) that includes consumers that the advertiser 105 is attempting to attract. The station 110 broadcasts the ad creative to radios 115 across the DMA according to the specifications of the advertising schedule. Notably, at the time that the ad creative is broadcast across the DMA, consumer response is gathered from DMAs other than the targeted DMA. The consumer response gathered from other DMAs can serve as a control group against which the consumer response in the targeted DMA can be compared to determine an effectiveness of the ad campaign.

Consumers 120 listen to the ad creative. The consumers 120 can reside in the geographic region across which the broadcast spans. In addition, consumers 120 can include those that reside outside the geographic region and are passing through the region at times when the ad creative is presented on the radio 115. Having listened to the ad creative on the radio 115, the consumers 120 access a computer 125 that is connected to the Internet and visit the advertiser's website 130 by entering the URL to the website 130 provided in the ad creative in a web browser. Alternatively, or in addition, the consumers 120 use either a landline telephone 135 or a cellular telephone 140 or both to call an advertiser's telephone 145, the number for which was included in the ad creative. Further, the consumers 120 can contact the advertiser based on the SMS text, SMS codes, coupon codes, and the like, that are included in the ad creative.

In some implementations, a monitoring system 150, that will be described later, is operatively coupled to the advertiser's website 130 and the advertiser's telephone 145 to detect these communications by the consumers 120. The monitoring system 150 can have previously received information related to the product from the advertiser. For example, at the time the advertiser provided the ad creative and the advertising schedule to the advertisement broadcasting station 110, the advertiser can have provided all information related to the product that is included in the ad creative as well as the advertising schedule to the monitoring system 150. When the monitoring system 150 detects communications from consumers 120 to the advertiser, then the monitoring system 150 can identify those communications that are related to the product for which information was received from the advertiser 105. Based on this identification, the monitoring system 150 can determine a number of consumers 120 enquiring about the advertised product.

Using techniques described below, the monitoring system 150 can generate a correlation between the number of enquiring consumers 120 and a duration of the advertising schedule, and generate an effectiveness report 155 describing the correlation. In some implementations, the effectiveness report 155 includes data collected during the advertising schedule plotted against the duration of the schedule. The effectiveness report 155 can represent a comparison of data collected during the advertising schedule to data collected for a comparable duration prior to and/or after the advertising schedule. Also, the effectiveness report 155 can represent a comparison of data collected in targeted geolocations during the advertising schedule to data collected in comparable non-targeted geolocations during the same period. For the comparison, data can also be collected from the non-targeted geolocations at different times relative to the advertising schedule, such as, before, during, and after the advertising schedule. A geolocation, targeted or non-targeted, can be regions including countries, states, cities, and the like.

For example, the effectiveness report 155 can include a plot of an increase in a number of visits to the advertiser's website 130 during the advertising schedule in comparison to a number of visits absent the advertising plotted for each day in the schedule. Subsequently, the monitoring system 150 can transmit the effectiveness report 155 to the advertiser 105. The effectiveness report 150 provides the advertiser with real-time feedback based on which the advertiser 105 can determine an ROI for the advertising. Techniques for monitoring communications from the consumers 120 and generating the effectiveness report 155 will be described with reference to the figures that follow.

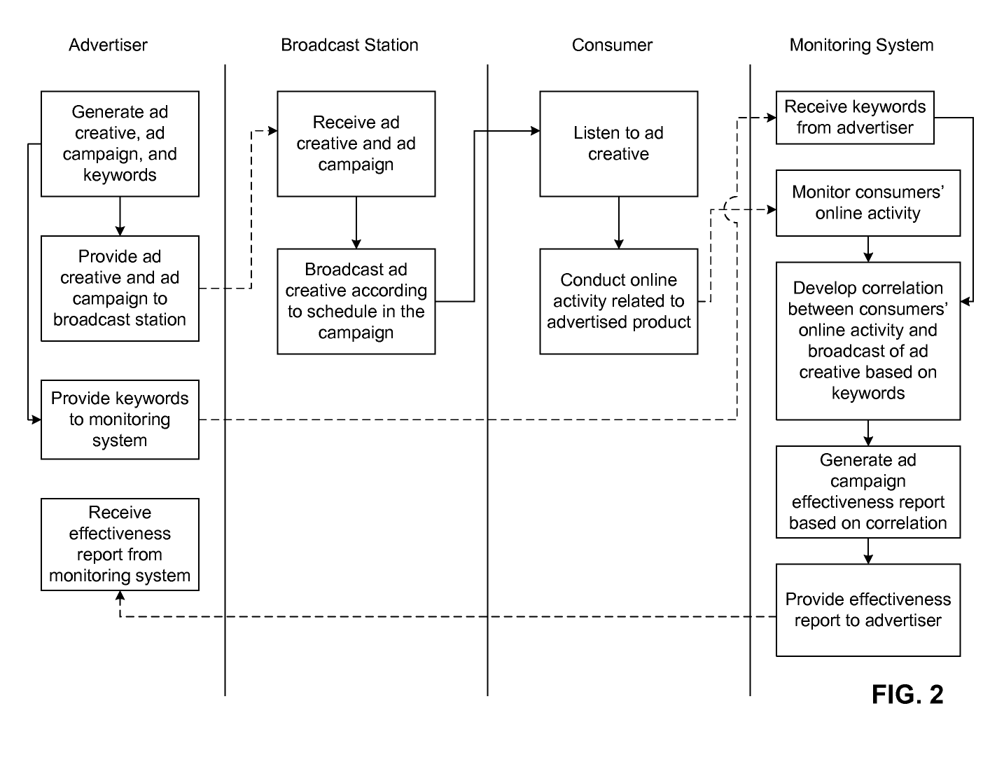

FIG. 2 is a flow chart of an example process 200 for online monitoring of offline advertising effectiveness. The persons and components that perform the operations of process 200 include the advertiser 105, the advertisement broadcasting station 110, the consumer 120, and the monitoring system 150, described previously with reference to FIG. 1. The advertiser 105 generates the ad creative, ad campaign, and keywords related to the product being advertised. The advertiser 105 provides the ad creative and the ad campaign to the advertisement broadcasting station 110 and provides the keywords to the monitoring system 150. The advertisement broadcasting station 110 receives the ad creative and the ad campaign, and broadcasts the ad creative according to the advertising schedule specified in the campaign to consumers, for example, who are located in a geographic region. In some implementations, the station 110 can be a radio station that broadcasts the ad creative over air waves. Alternatively, or in addition, the station 110 can be a television station that transmits the ad creative through, for example, satellites, a publisher that publishes the ad creative in a newspaper, and the like.

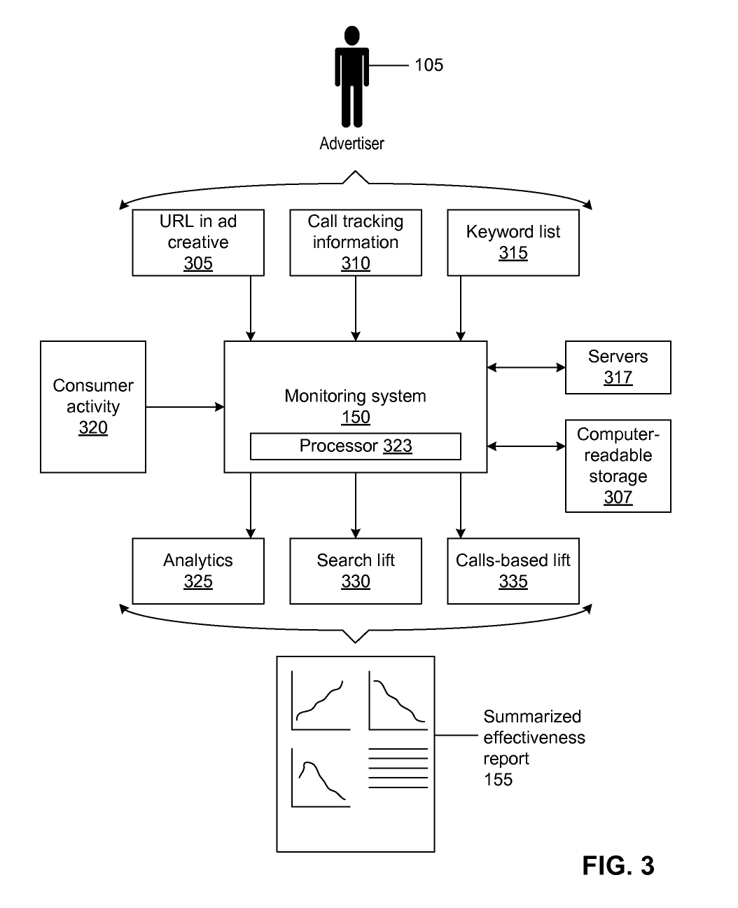

In implementations where the station 110 is a radio station, a consumer 120 listens to the ad creative on the radio and conducts online activity, for example, on the Internet, related to the advertised product. As described later, the monitoring system 150 is operatively coupled to the Internet to monitor consumers' online activity. For example, the monitoring system 150 receives the keywords from the advertiser 105 and detects instances when one or more of the keywords received from the advertiser 105 are used as search terms for searches on the Internet. Specifically, the advertiser 105 provides keywords when the advertisement is presented in print and/or on the television. The monitoring system 150 also determines if any of the detected searches are conducted from within the geographic region to which the broadcasting station 110 broadcasts and are conducted during the ad campaign. In this manner, based on the keywords received from the advertiser 105, the monitoring system 150 develops a correlation between consumers' online activity and the broadcast of the ad creative. Using techniques described with reference to FIG. 3, the monitoring system 150 generates an ad campaign effectiveness report based on the correlation, and provides the effectiveness report to the advertiser 105. The effectiveness report provides the advertiser 105 with feedback related to the ad campaign and enables the advertiser to modify the advertising schedule in the ad campaign, for example, in the middle of the ad campaign.

FIG. 3 is a schematic of an example monitoring system 150. The monitoring system 150 can be any data processing apparatus that can be configured to receive a computer-readable medium that includes software instructions that are executable to cause one or more computers to perform multiple operations. Some of the operations that the monitoring system 150 can perform include receiving information related to an advertisement and an advertisement campaign from an advertiser 105. For example, the monitoring system 150 can receive from the advertiser 105, a URL 305 of a website mentioned in the ad creative, call tracking information 310 to track telephone calls to a telephone number mentioned in the creative, and a keywords list 315 that includes keywords related to the product and generated by the advertiser 105.

The monitoring system 150 can be connected to a network, for example, the Internet, and the advertiser 105 can access the monitoring system 150 using, for example, a computer, connected to the Internet. In some implementations, the monitoring system 150 can provide the advertiser 105 with a website in which the advertiser 105 can provide information about the advertisement and the advertisement campaign. To host the website, the monitoring system 150 can either include one or more servers or can be operatively coupled to one or more servers 317. For example, the advertiser 105 can access a URL to the website provided by the monitoring system 150 by entering the URL in a web browser displayed in a display device of a computer. If the advertiser 105 is accessing the URL of the monitoring system 150 for the first time, then the monitoring system 150 can request the advertiser 105 to create an account under which the monitoring system 150 can store all information related to the advertiser 105. To create an account, the advertiser 105 can provide, for example, personal information which the monitoring system 150 can store in a repository on the server 317. Additionally, the advertiser 105 can create a user-name and a password to access the created account, using which the monitoring system 150 can verify the advertiser 105 during subsequent visits.

Upon determining that the advertiser 105 has created an account on the website, the monitoring system 150 can provide a webpage in which the advertiser 105 can provide information about the advertisement and the advertisement campaign. In some implementations, the monitoring system 150 can provide a textbox in which the advertiser 105 can enter the URL that will be mentioned in the ad creative. Alternatively, the monitoring system 150 can provide a checkbox in the webpage. By checking the checkbox, the advertiser 105 can indicate that a URL is included in the ad creative and the monitoring system 150, in response, can provide the text box in which the URL can be entered. In some implementations, the website provided by the monitoring system 150 can be configured to ask the advertiser 105 if additional URLs will be mentioned in the ad creative and to provide additional textboxes to enable the advertiser 105 to enter the additional URLs. In this manner, the monitoring system 150 receives URLs 305 in the ad creative from the advertiser 105.

In addition, the advertiser 105 can enter call tracking information 310 into the website provided by the monitoring system 150. Call tracking refers to monitoring telephone calls to a telephone number to gather statistics. For example, if an advertisement mentions a telephone number that a consumer can call, then call tracking describes the process of monitoring a number of telephone calls to the telephone number, a duration of each call, a number of consumers who purchase the advertised product over the telephone, and the like. In some implementations, as call tracking information 310, the advertiser 105 can enter one or more telephone numbers that will be mentioned in the ad creative. The monitoring system 150 can include a call tracking solution to monitor telephone calls to the telephone number or numbers provided by the advertiser 105. Alternatively, the advertiser 105 can employ their own preferred call tracking solution. In such scenarios, the monitoring system 150 enables the advertiser 105 to specify the use of a preferred call tracking solution, and to provide data gathered by the advertiser's call tracking solution. For example, the website includes a checkbox that the advertiser 105 selects to indicate the use of a preferred call tracking solution. Further, the website enables the advertiser 105 to upload a file including call tracking data to the website's server. In some implementations, the monitoring system 150 can specify that the call tracking data uploaded by the advertiser 105 be a comma separated value (csv) file that includes a time stamp, for example, including date and time, for each phone call, a telephone number that is being tracked, a duration of the telephone call, and the like. In some implementations, the monitoring system 150 can be configured to combine the call tracking solution included in the system 150 and the call tracking solution preferred by the advertiser 150 to monitor telephone calls to the telephone number or numbers mentioned in the ad creative.

The advertiser 105 can also provide a keywords list 315 that include keywords that consumers can use when performing Internet searches for the advertised product. In some implementations, the website provided by the monitoring system 150 can include textboxes into which the advertiser 105 can enter keywords. For example, the monitoring system 150 can display four groups of textboxes to the advertiser 105 into which the advertiser 105 can provide four types of keywords. The first group includes keywords associated with the advertiser 105, for example, the advertiser's name, a city where the advertiser is located, and the like. The second group includes keywords associated with the ad creative, for example, one or more words mentioned in the ad creative. The third group includes the general industry of the advertiser, for example, a generic name of the product being advertised. The fourth list includes keywords associated with the advertiser's competitors, for examples, competitors' names, competitors' products, and the like. Each group can include multiple textboxes into which the advertiser 105 can enter keywords. The monitoring system 150 can add textboxes to each group in response to input from the advertiser 105. In some implementations, in addition to the four groups described above, the monitoring system 150 can enable the advertiser to specify an additional group, for example, by providing a checkbox that the advertiser 105 can select. Upon detecting that the advertiser 105 has selected the checkbox, the monitoring system 150 can cause the website to display an additional group of textboxes into which the advertiser 105 can provide a new group of keywords.

In some implementations, the monitoring system 150 can store the URL 305, the call tracking information 310, and the keyword list 315 in a computer-readable storage 307 included in or operatively coupled to the system 150. For example, the monitoring system 150 can store the information received from the advertiser 105 in the computer-readable storage 307 in tables including multiple rows and columns, such that each row represents an advertiser 105 and the cells in the row store the advertiser's name, account information, ad campaign schedule, ad creative, URL 305, call tracking information 310, keyword list 315, and other information received from the advertiser 105. Such other information can include the advertisement schedule, the DMAs where the advertisement will be presented, and the like. In some implementations, the table in which the information is stored can be a computer-searchable index.

In some implementations, the monitoring system 150 can track consumer activity 320 based on the information received from the advertiser 105. Consumer activity 320 refers to all forms of activity related to the product being advertised offline, that are performed by the consumers and that can be tracked using online techniques. For example, consumer activity 320 includes a consumer's visit to the URL 315 presented in the ad creative, a consumer's telephone call to the number provided in the ad creative, a consumer's search for a keyword describing the advertised product, a consumer's purchase of the product subsequent to visiting the website specified in the creative, a consumer's entry of SMS text, a consumer's use of coupons, a consumer's participations in online surveys, and the like. Such online surveys include questionnaires related to brand awareness of an advertiser's brand.

The monitoring system 150 can be configured to track consumer activity 320 for a duration which can depend upon factors including the advertising schedule, the DMA, and the like. For example, to determine a number of consumers within the advertised DMA that express interest in an advertised product using online techniques, the monitoring system 150 can track consumer activity 320 within the DMA during the advertising schedule. In addition, to detect an increase in consumer interest as a result of the ad campaign, the monitoring system 150 can track consumer activity 320 within the DMA for a duration before the ad schedule, and, in some implementations, for a duration after the ad campaign. For example, if the advertiser provides information to the monitoring system 150 indicating that the ad campaign will last for one week, then the monitoring system 150 can monitor consumer activity 320 for a week or longer before the beginning of the ad campaign and for a week or longer after the conclusion of the ad campaign. Alternatively, or in addition, the monitoring system 150 can receive specific durations from the advertiser 105 specifying when the consumer activity 320 should be monitored.

Based upon the information received from the advertiser 105, the monitoring system 150 tracks the consumer activity 320 for the a duration and stores the tracked information in a computer-readable storage medium, for example, storage 307. The monitoring system 150 can measure online interest by daily counts of the number of search queries that contain one or more keywords in the keyword list 315, by the number of consumers that visit the advertiser's website by accessing the URL 305, by the number of pageviews at the advertiser's website, by the total duration of visits to the advertiser's website, by a number of telephone calls to the telephone number provided in the call tracking information 310, and the like. The monitoring system 150 includes a processor 323 that is configured to perform a regression analysis to estimate the incremental value of the ad campaign beyond a baseline interest in the advertiser's product that would have been seen in the absence of the advertisement. The baseline interest in the advertiser's product can be assessed as a function of daily counts of the number of search queries that contain one or more keywords in the keyword list, by the number of consumers that visit the advertiser's website by accessing the URL, by the number of pageviews at the advertiser's website, by the total duration of visits to the advertiser's website, by a number of telephone calls to the telephone number provided in the call tracking information, and the like, that are measured for the duration before and after the running of the ad campaign.

In some implementations, to determine the effectiveness of the offline ad campaign, the processor 323 in the monitoring system 150 is configured to determine two measures. The first measure is an incremental effect δ defined as the average daily difference between a number of consumers performing consumer activity 320 during the ad campaign (y₁) in the DMA and the predicted number of consumers performing consumer activity 320 (y₀) that would have been observed during the same duration had the ad campaign not been run. In some implementations, the predicted number of consumers performing consumer activity 320 (y₀) can be determined using a function of the number of consumers in non-targeted geolocations during the campaign. The incremental effect can be represented by equation 1.

δ=ave(y₁−y₀) (1)

The second measure is the relative effect on the average number of consumers over the advertisement schedule (λ), known as lift. In other words, λ is the difference in the average number of consumers with the campaign relative to the average number of consumers without the campaign, or the average incremental effect relative to the baseline without the campaign. The lift can be represented by equation 2.

λ=[ave(y₁−y₀)/ave(y₀)]=δ/ave(y₀) (2)

In equation 2, the average is taken over the duration in a fixed period after the campaign.

The predicted number of consumers performing consumer activity 320 (y₀) that would have been observed during the same duration as the advertising schedule in the absence of the ad campaign having not been run cannot be determined by monitoring. Therefore, the processor 323 uses the number of consumers performing consumer activity 320 before the ad campaign is run (y′₀) to infer y₀. To do so, in some implementations, the monitoring system 150 tracks daily consumer activity 320 for the same duration before the ad campaign as the duration of the ad campaign. The processor 323 is configured to perform a least squares line fit that relates the daily pre-campaign visits in the target DMA to the daily pre-campaign visits in the non-targeted DMAs. Substituting y′₀ in place of y₀ in equation (1) yields the estimated lift statistics, as represented by equations 3 and 4.

δ′=ave(y₁−y₀) (3)

λ′=ave(y₁−y′₀)/(ave(y′₀) (4)

Thus, the processor 323 is configured to perform the mathematical operations represented by equations 1-4 to calculate δ′ and λ′. In addition, the processor 323 can be configured to perform additional calculations described in the document entitled “Online Effects of Offline Ads” by Diane Lambert and Daryl Pregibon, presented at the Proceedings of the Second International Workshop on Data Mining and Audience Intelligence for Advertising (ADKDD 2008), the entire contents of which are incorporated herein by reference.

Subsequent to performing the mathematical operations including determining estimated incremental effect and the estimated lift statistics represented by equations (3) and (4), the monitoring system 150 provides as an output a summarized effectiveness report 155 that includes multiple metrics describing the campaign performance and representing the correlation determined by the mathematical operations for the DMA in which the advertisement was presented.

The metrics related to campaign performance depend on the offline media in which the advertisement was presented. For example, if the advertisement was presented in one or more radio stations within a DMA, then the report 155 can include audio metrics including the dates of the campaign, a number of times the ad creative was played, a number of radio stations in the DMA, a number of unique listeners that heard the ad creative, a number of times the unique listeners heard the ad creative, and the like. Similarly, if the advertisement was published, then the print metrics can include the dates of the campaign, size of the ad creative in the publication, sections of newspapers where the ad creative was placed, frequency of insertions, circulation of each newspaper, and the like.

For ad campaigns in radio stations, play data, list of stations, and market information can be obtained commercially, for example, from the advertising agency or the radio station or from an automated system that gathers such information. In some implementations, play data can be received by automated systems deployed at the radio station. The data can be verified by automated verification systems that are tuned into the radio stations' broadcasts. Also, audio systems can include subsystems that use listenership data, for example, Arbitron listenership data, to provide metrics including unique listeners and the number of times a unique listener heard an advertisement. Data related to number of unique listeners and the number of times the unique listeners heard the ad creative can be provided by an inventory management system.

In some implementations, the monitoring system 150 can present the correlation between the increase in consumers' interest in response to and the duration of the ad campaign via multiple metrics including analytics 325, search lift 330, and calls-based lift 335. Analytics 325 refers to the increase in consumers' interest as determined by visits to the URL 305 mentioned in the ad creative. Analytics 325 can include a number of unique visitors to the advertiser's website, a number of pageviews of the web pages of the website, a percentage increase in a number of visitors compared to baseline prior to the ad campaign, a percentage increase in a number of pageviews compared to baseline prior to campaign, a ratio of a number of consumers who listened to the ad creative on the radio station to a number of consumers who visited the website, and the like. The processor 323 can calculate the baseline for both the number of unique visitors and the number of pageviews based on the consumer activity 320 tracked for a duration, for example, four weeks, prior to the duration of the ad campaign. For example, based on the analytics 325, the advertiser 105 can conclude that during the ad campaign, there was a 25% increase in the number of visitors, a 30% decrease in the number of pageviews, and that one of every 100 listeners who heard the advertisement on a radio station visited the advertiser's website.

Search lift 330 refers to the increase in consumers' interest as determined by Internet searches performed by consumers for keywords that are among or are similar to keywords in the keyword list 315. Search lift 330 can include a percentage lift of advertiser related keywords, a percentage lift of campaign related keywords, and the like. The advertiser related keywords can include the advertiser's name, product, and the like. Campaign related keywords can include the product name, words related to special deals being offered by the advertiser, words related to a duration for which the deals are valid, and the like. determining the search lift 330, the monitoring system 150 can normalize the search queries by the total volume of the queries, the industry terms, competitors, and the like. For example, based on the search lift 330, the advertiser 105 can conclude that during the ad campaign, there was a 10% increase in searches on keywords related to the advertiser's brand, and a 5% increase in searches on keywords related to the ad creative.

Calls-based lift 335 refers to the increase in consumers' interest as determined by telephone calls to the telephone number or numbers mentioned in the ad creative. Calls-based lift 335 can include a number of calls, ratio of number of listeners to unique phone numbers, and the like. For example, based on the calls-based lift 335, the advertiser can conclude that during the ad campaign, a total of 500 calls were received, and that one out of every 1000 consumers who listened to the ad creative broadcast by the radio station called the telephone number provided in the ad creative.

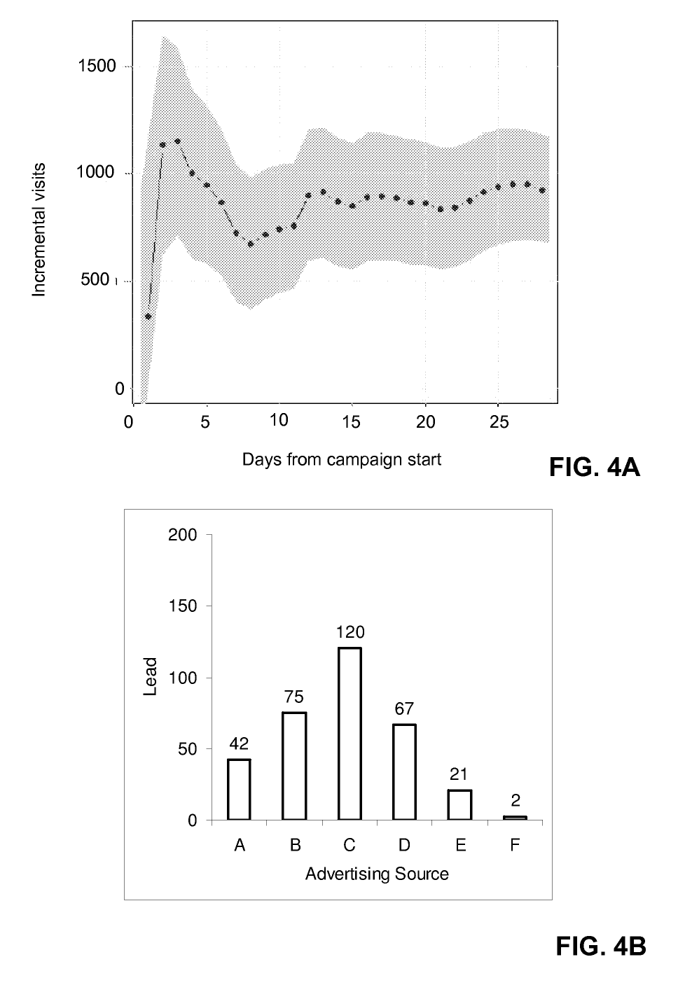

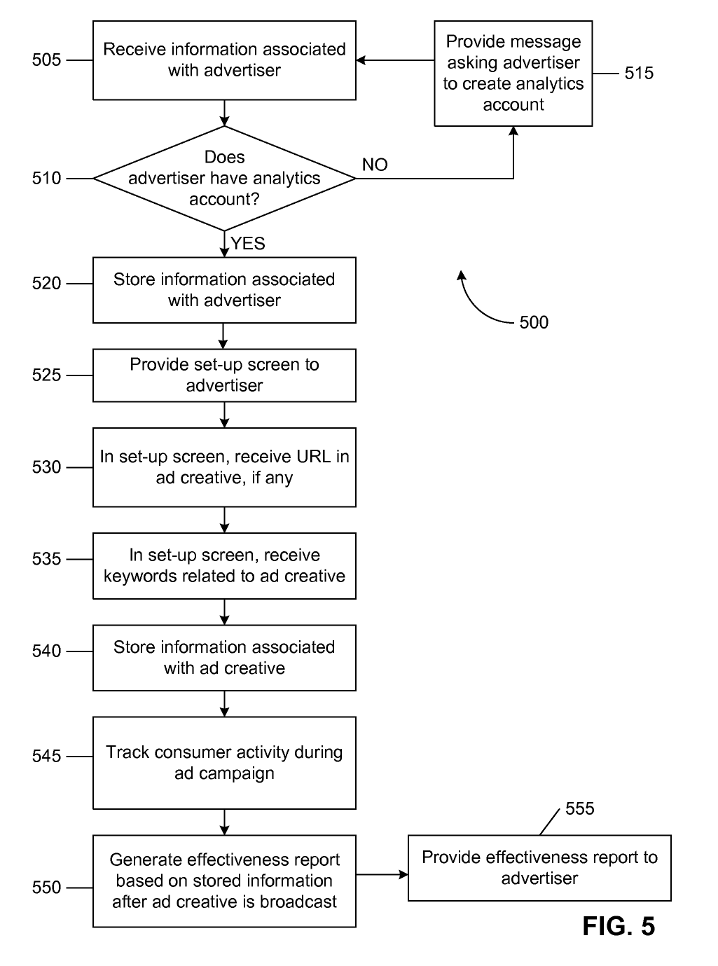

In some implementations, the analytics 325, the search lift 330, the calls-based lift 335, and any other metrics determined by the monitoring system 150 can be provided to the advertiser 105 in the form a summarized effectiveness report 155 that includes one or more plots. FIGS. 4A and 4B are plots included in a summarized effectiveness report 155. FIG. 4A is a plot of incremental visits to an advertiser's website plotted against days from the start of the ad campaign. For example, with respect to FIG. 4B, the advertiser 105 presented an ad creative in multiple DMAs, labeled in FIG. 4B as advertising sources A-F. The monitoring system 150 collected call tracking information 310 for each DMA and tracked consumer activity 320 in response to the advertisement. The processor 323 determined calls-based lift 335 for each market which the monitoring system 150 displayed as a plot of calls-based lift (lead) v/s advertising source. The processes performed by the monitoring system 150 to generate the effectiveness report 155 are explained with reference to FIG. 5.

FIG. 5 is a flow chart of an example process 500 for generating an effectiveness report. The process 500 receives information associated with the advertiser at 505. The information includes information related to an advertisement for a product that is presented through offline media that does not include the Internet. The information also includes an advertising schedule based on which the advertisement is to be presented to a market including consumers. An advertiser intending to promote a product in one or more DMAs provides this information.

The process 500 checks if the advertiser has an analytics account at 510. For example, the monitoring system 500 displays a user interface requesting the advertiser to specify if the advertiser is an existing account holder or a new user.

Upon determining that the advertiser does not have an analytics account, the process provides a message asking advertiser to create an analytics account at 515. For example, if the advertiser is a new user, then the monitoring system 150 presents the advertiser with a webpage including textboxes into which the advertiser can provide personal information to create an account, as described previously.

The process 500 stores the information associated with the advertiser at 520. For example, if the advertiser is a new advertiser, then the monitoring system 150 stores the advertiser's analytics account information in addition to the information associated with the advertisement.

The process 500 provides a set-up screen to the advertiser at 525. For example, to enable the advertiser to provide information related to the ad creative, the monitoring system 150 provides a user interface. The monitoring system 150 displays the user interface in, for example, a web browser, into which the advertiser can provide specific information related to the ad creative.

The process 500 receives URL in ad creative, keywords related to the ad creative, at 530 and 535, respectively. For example, the monitoring system 150 receives from the advertiser in one or more textboxes, one or more URLs that will be mentioned in the ad creative and one or more keywords describing the advertiser, the product, and the like.

The process 500 stores the information associated with the ad creative at 540. For example, the monitoring system 150 stores the received information in a computer-readable and computer-searchable storage medium.

The process 500 tracks consumer activity during the ad campaign at 545. For example, the monitoring system 150 collects data including a number of visits to the advertiser's website, a number of telephone calls to the telephone number mentioned in the ad creative, a number of searches for one or more keywords in the keyword list, and the like, as described with reference to FIG. 3.

The process 500 generates an effectiveness report based on stored information after ad creative is broadcast at 550. For example, the monitoring system 150 calculates a correlation between an increase in consumers' interest in an advertiser's product during the ad campaign with the duration of the ad campaign, and generates an effectiveness report, as described previously.

The process 500 provides the effectiveness report to the advertiser at 555. For example, the monitoring system 150 can generate the effectiveness report and display the report to the advertiser when the advertiser accesses the previously created analytics account.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a random or serial access memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other module suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the specification or of what may be claimed, but rather as descriptions of features specific to particular implementations of the specification. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the specification have been described. Other implementations are within the scope of the following claims. For example, the actions recited in the claims can be performed in a different order and still achieve desirable results.

In some implementations, during the duration of the advertising campaign, the monitoring system 150 can track consumer activity across multiple DMAs including the DMA of the ad campaign simultaneously. In such implementations, the monitoring system 150 can use the consumer activity in the DMAs that where the advertisement is not presented as a control against which the monitoring system 150 can compare the consumer activity in the DMA where the advertisement is presented. Also, in such implementations, the monitoring system 150 may not track the consumer activity for durations before and after the ad campaign. In alternative implementations, the monitoring system 150 can track consumer activity in multiple markets for durations including before during and after the ad campaign to generate correlation data. In some implementations, as an alternative or in addition to using computers to enter keywords, users can use SMS messaging services to search for the advertised product.

What is claimed is:

1. A method performed by one or more computers, the method comprising:
receiving, by one or more computers, information related to an advertisement for a product, wherein the advertisement is presented through offline media other than a public, packet-switched data network and wherein the information includes an advertising schedule based on which the advertisement is to be presented to a market including consumers;
detecting, by the one or more computers, communications related to the product from the consumers in the market at times in the advertising schedule during which the advertisement is presented, the detected communications received through offline media and a public, packet-switched data network;
collecting, by the one or more computers, data responsive to the detected communications, the data representing a number of consumers in the market from whom the communications related to the product were detected responsive to the advertisement;
determining, by the one or more computers, a statistical correlation between the collected data and the advertising schedule, the statistical correlation representing an effectiveness of presenting the advertisement for the product during the advertising schedule; and
providing, by the one or more computers, a report of the effectiveness based at least in part on the determined statistical correlation.

2. The method of claim 1, further comprising:
detecting communications related to the product from consumers in a market other than the market in which the advertisement is presented;
collecting other data responsive to the communications detected from the market other than the market in which the advertisement is presented; and
including the other data in determining the statistical correlation.

3. The method of claim 1, further comprising:
receiving the information related to the advertisement from an advertiser; and
providing the statistical correlation representing the effectiveness to the advertiser.

4. The method of claim 1, wherein the information includes a website of the product that is stated when the advertisement is presented, the communications related to the product includes an accessing of the website, and the collected data includes a number of times consumers access the website.

5. The method of claim 1, wherein the public, packet-switched data network comprises the Internet.

6. The method of claim 5, wherein the information includes a keyword related to the product, the communications related to the product includes searches on the Internet for the keyword, and the collected data includes a number of times consumers search the Internet for the keyword.

7. The method of claim 1, wherein the information includes a telephone number to call to obtain information related to the product, the communications related to the product includes phone calls to the telephone number, and the collected data includes a number of times consumers placed the phone calls.

8. The method of claim 1, wherein the advertisement is presented through one or more of a radio, a television, or a publication.

9. The method of claim 1, further comprising:
detecting first communications related to the product from consumers in the market for a first time before the advertising schedule is commenced;
detecting second communications related to the product from consumers in the market for a second time after the advertising schedule is completed;
collecting data responsive to the first communications and the second communications, the data representing a number of consumers in the market from whom the communications related to the product were detected before and after the advertisement was presented; and
determining a change in a number of consumers that provided communications related to the product during the advertising schedule in comparison to a number of consumers that provided communications related to the product before and after the advertising schedule.

10. The method of claim 1, wherein the effectiveness of presenting the advertisement for the product during a plurality of days of the advertising schedule is represented by a plurality of numbers of consumers from whom communications related to the product were detected on the corresponding plurality of days, and wherein providing the statistical correlation comprises generating a graph of the plurality of numbers of consumers v/s the plurality of days.

11. A computer-readable medium encoding software instructions executable by one or more computers to perform operations comprising:
detecting, for a duration, visits to a website related to a product by consumers in a geographical region, the website identified in an advertisement for the product that is broadcast by a radio station to the geographical region, the duration corresponding to an advertising schedule during which the advertisement is broadcast by the radio station;
collecting a number of visits to the website at periodic intervals during the duration based on the advertising schedule;
determining an increase in a number of visits to the website in comparison to an average number of visits to the website for each of the periodic intervals during which the number of visits to the website is collected;
generating a plot of the increase in the number of visits to the website versus a number of periodic intervals; and
providing the generated plot to an advertiser from whom the advertisement was received.

12. The computer-readable medium of claim 11, wherein a visit to the website is defined by an accessing of a uniform resource locator (URL) of the website that is stated when the advertisement is broadcast by the radio station.

13. The computer-readable medium of claim 11, wherein a consumer is determined to be within the market if an IP address of a computer using which the consumer accesses the website is included in IP addresses of all computers located within the market.

14. The computer-readable medium of claim 11, wherein the average number of visits to the website is determined based on a number of visits to the website before the advertisement for the product is broadcast.
